(19) United States
(12) Patent Application Publication
(10) Pub. No.: US 2020/0202656 A1
(43) Pub. Date: Jun. 25, 2020

(54) LOCK AND APPARATUS COMPRISING THE SAME

(71) Applicant: IDEAS FOR LIFE LIMITED, Sheffield (GB)

(72) Inventor: Richard WILLIAMS, Sheffield (GB)

(21) Appl. No.: 16/637,686

(22) PCT Filed: Jul. 25, 2018
(86) PCT No.: PCT/GB18/52093

§ 371 Date: Feb. 7, 2020

(30) Foreign Application Priority Data
Aug. 10, 2017 (GB) 1712848.9
Sep. 21, 2017 (GB) 1715246.3

(51) Int. Cl. G07D 11/125

(52) U.S. Cl. CPC G07D 11/125

(57) ABSTRACT

A lock apparatus includes a carrier and lid, the carrier being adapted to receive bank notes and having side portions into which the lid can be slid to prevent access to the bank notes in the carrier. The side portions of the carrier having mechanisms for engaging with side portions of the lid. The lid has a leading edge including a first member shaped to form an irreversible lock with a correspondingly shaped second member on the carrier. One of the first and second members includes a male member and the other of the first and second members includes a female member.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This invention relates to a lock, in particular to a lock suitable for use with an apparatus for the tamper proof storage and transportation of banknotes or other items, and to such an apparatus comprising the lock.

### 2. Description of Related Art Including Information Disclosed Under 37 CFR 1.97 and 37 CFR 1.98.

It is known to provide portable banknote carriers into which notes can be inserted but not subsequently withdrawn without leaving evidence that there has been tampering. Carriers of this type are commonly used at tills where for security cashiers can insert banknotes when the stack of notes in a till exceeds a particular level, then at periodic intervals or the end of the day the carriers are locked, removed from their location at the till, marked with the till identification and handed over for counting and banking.

With such a system it is not necessary for the cashier to count the money put into the carrier because it will be evident if there had been tampering after the carrier has left the till. Nowadays it is often preferred for the carriers to be counted at an ‘out of house’ central accounting location or bank that may be remote from the original cashier's location. The carrier may be handled by individuals from different organisations such as security transportation firms. Thus, as well as requiring resistance to tampering, the carrier and its lid are preferably lightweight and recyclable, due to the cost and inconvenience of returning carriers.

Published European Patent Application EP 1314144 A1 describes one such system, in which a carrier is locked in place in a support structure for receipt of banknotes and when it is required to remove the carrier this can only be done after a tamper-proof lid has been inserted over the carrier. The mechanism is designed so that during the procedure of attaching the lid and subsequent removal of the carrier from the supporting structure it is not possible to remove notes. The lid slides over the carrier in one direction only and there are end stops that lock when the lid is fully engaged, and at that point release from the support structure is enabled. Access to the carrier requires breakage of the end stops so that the lid can be slid, in the same single direction, off the carrier at the opposite end from which it was introduced.

It was found, however, that the channels of the lid and carrier top in such an arrangement, when made thin or of some plastics materials, had sufficient flexibility for them to be prized apart and notes removed without leaving evidence of tampering. Since it is clearly desirable to make sure this cannot happen without having to make the relevant parts of thicker or different materials. Indeed it is preferable to be able to make the parts thinner in some instances, or of more easily recyclable materials, improved arrangements were developed. Published European Patent EP 1839281 B1 describes one such improved arrangement, which comprises an apparatus comprising a carrier and lid, the carrier being adapted to receive bank notes and having side portions into which the lid can be slid to prevent access to the bank notes in the carrier, the side portions of the carrier having means for engaging with side portions of the lid, wherein the means for engaging overlap said side portions of the lid in the ‘vertical’ direction normal to the plane of the lid to resist separation in said direction of the lid and carrier at their side margins.

### BRIEF SUMMARY OF THE INVENTION

The present invention arose during development of a yet further improved apparatus for the tamper proof storage and transportation of banknotes. It should be noted that whilst the apparatus of the present invention is provided with the storage and transport of bank notes in mind, the apparatus may be used (or adapted within the scope of the claims) for the tamper proof storage and transport of other items, including but not limited to other forms of payment slips (postal orders, cheques, credit card slips, coupons and or pre-paid vouchers), for example. In a similar regard, it should be appreciated that the lock may find application beyond the field of bank note storage and transportation.

According to the present invention in a first aspect, there is provided an apparatus comprising a carrier and lid as recited by claim 1.

According to the present invention in further aspects, there are provided:

An apparatus comprising a carrier and lid, the carrier being adapted to receive bank notes, or other items, and having side portions into which the lid can be slid to prevent access to the bank notes, or other items, in the carrier, the side portions of the carrier having means for engaging with side portions of the lid, the lid having a leading edge comprising a first member shaped to form an irreversible lock with a correspondingly shaped second member on the carrier, one of the first and second members comprising a male member and the other of the first and second members comprising a female member, wherein the female member comprises a mouth for receiving the male member and a shield, which projects from the mouth.

An apparatus comprising a carrier and lid, the carrier being adapted to receive bank notes, or other items, and having side portions into which the lid can be slid to prevent access to the bank notes, or other items, in the carrier, the side portions of the carrier having means for engaging with side portions of the lid, the lid having a leading edge comprising a first member shaped to form an irreversible lock with a correspondingly shaped second member on the carrier, one of the first and second members comprising a male member and the other of the first and second members comprising a female member, wherein a surface of the lid that faces the carrier comprises a recess immediately adjacent to the first member.

An apparatus comprising a carrier and lid, the carrier being adapted to receive bank notes, or other items, and having side portions into which the lid can be slid to prevent access to the bank notes, or other items, in the carrier, the side portions of the carrier having means for engaging with side portions of the lid, the lid having a leading edge comprising a first member shaped to form an irreversible lock with a correspondingly shaped second member on the carrier, one of the first and second members comprising a male member and the other of the first and second members comprising a female member, wherein the female member comprises a mouth for receiving the male member and a barrier is provided inside the female member immediately adjacent the mouth.

An apparatus comprising a carrier and lid, the carrier being adapted to receive bank notes, or other items, and having side portions into which the lid can be slid to prevent access to the bank notes, or other items, in the carrier, the side portions of the carrier having means for engaging with side portions of the lid, the lid having a leading edge comprising a first member shaped to form an irreversible lock with a correspondingly shaped second member on the carrier, one of the first and second members comprising a male member and the other of the first and second members comprising a female member, wherein the male and female members each comprise a serrate part, which projects in a direction normal to the plane of the lid when the lid and the carrier are engaged, the serrate parts of the male and female members being positioned to engage one another to prevent withdrawal of the lid from the carrier, wherein the female member comprises a mouth for receiving the male member and a barrier is provided inside the female member, and wherein the serrate part of the female member projects from the same surface as the barrier and is located inside the female member from the barrier.

An apparatus comprising a carrier and lid, the carrier being adapted to receive bank notes, or other items, and having side portions into which the lid can be slid to prevent access to the bank notes, or other items, in the carrier, the side portions of the carrier having means for engaging with side portions of the lid, the lid having a leading edge and a trailing edge, the leading edge comprising a first member shaped to form an irreversible lock with a correspondingly shaped second member on the carrier, one of the first and second members comprising a male member and the other of the first and second members comprising a female member, and the trailing edge comprising a third member shaped to form an irreversible lock with a correspondingly shaped fourth member on the carrier, one of the third and fourth members comprising a male member and the other of the third and fourth members comprising a female member, and a cover fixed to the lid for covering the third member to prevent access thereto.

It is to be noted that any of the above aspects may be taken in isolation or in combination with any one, more or all of the remaining aspects.

Further, preferred, features are presented in the dependent claims.

### BRIEF DESCRIPTION OF THE SEVERAL VIEWS OF THE DRAWINGS

Embodiments of the invention are described below with reference to the accompanying drawings.

FIG. 1 is a perspective view of an example carrier.

FIG. 2 is a perspective view of part of the carrier shown in FIG. 1.

FIG. 3 is a perspective view of an example lid, suitable for use with the carrier shown in FIG. 1.

FIG. 4 is a perspective view of part of the lid shown in FIG. 3.

FIG. 5 illustrates sectional views of the carrier and lid shown in FIGS. 1 and 3.

FIG. 6 is a perspective view from below of a carrier having a bag for bank notes attached to it.

FIG. 7 is another perspective view of the carrier and bag shown in FIG. 6.

FIG. 8 is a further partial perspective view of the carrier and bag shown in FIG. 6.

FIG. 9 is a top perspective view of a male member of a lock according to the present invention.

FIG. 10 is a bottom perspective view of the male member of FIG. 9.

FIGS. 11a and 11b are partial top perspective views of alternative female members of a lock according to the present invention.

FIG. 12 is a partial perspective view of a leading portion of a frame of the carrier with the insert that defines the female member removed.

FIG. 13 is a partial top perspective view of the lock according to the present invention in an engaged state.

### DETAILED DESCRIPTION OF THE INVENTION

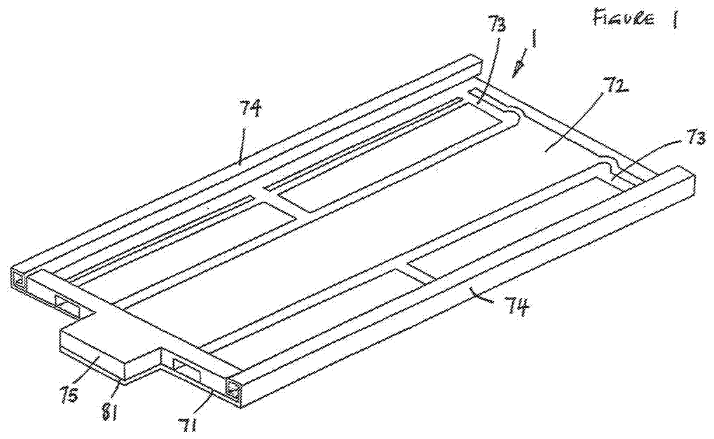

FIGS. 1 to 8 relate to an example apparatus in accordance with that shown in EP 1839281 B1. The entire contents of EP 1839281 B1 are incorporated herein by reference. It is to be noted that whilst the apparatus of the example omits features of the lock as required by the present invention, in accordance with embodiments of the present invention, the example apparatus will be modified to include the required lock, as described with reference to the embodiments of FIGS. 9 to 12, by suitable modification/replacement of the inserts 75 and 93 (described below). Such an apparatus, in accordance with the present invention, may be further modified in accordance with the features omitted here but disclosed in Published British Patent Application GB 2455558 A, the contents of which are also incorporated herein by reference.

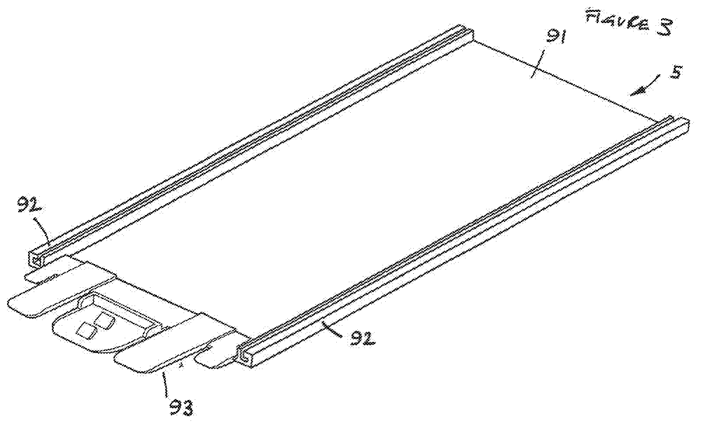

FIG. 1 is a perspective view of a carrier 1 according to the example. It comprises a flat base 71 which has a large central longitudinal aperture 72 and two side flaps 73, which are apertured to reduce material and to make them more flexible. At each side margin of the base is a respective one of two box-section longitudinal channels 74 to be further described with reference to FIG. 5. The channels fully embrace the corresponding side portions of the lid (shown in FIG. 3). At the forward end of the carrier is an insert 75 which spans the carrier between the leading ends of the channels 74.

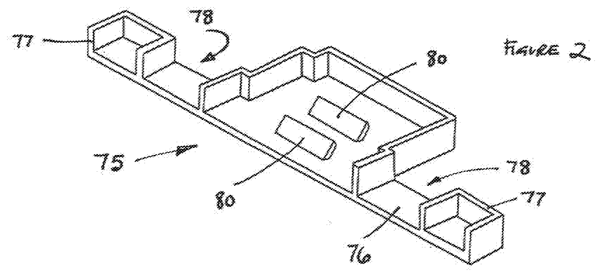

FIG. 2 shows the insert 75 (upturned from its orientation in FIG. 1), which comprises an elongate plate 76 having integral therewith an open box section 77 at each end, partly to add strength, partly to receive forward projections of the lid and partly to define a respective aperture 78 with a central open box section 79. Within the central box section 79 are disposed on the plate 76 are raised serrations 80 which face substantially in the ‘vertical’ direction. The central box section fits over a correspondingly sized and shaped front tab 81 (FIG. 1) extending forwardly from the base 71 of the carrier 1.

FIG. 3 illustrates a lid 5 for use with the carrier 1 shown in FIG. 1. It comprises a generally flat plate 91 and two longitudinal side portions which fit slidingly into the channels 74 of the carrier 1. At its front end the lid comprises an insert 93.

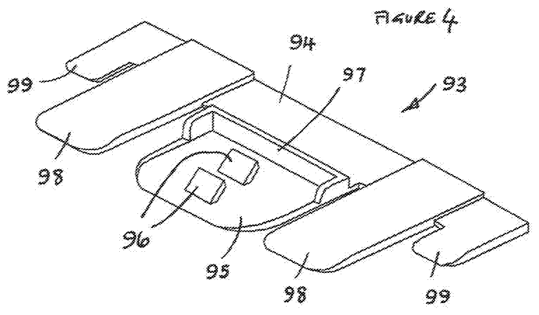

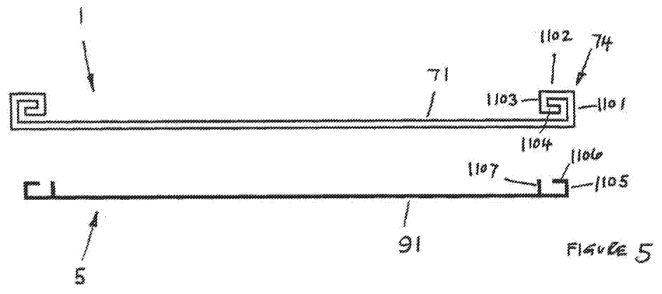

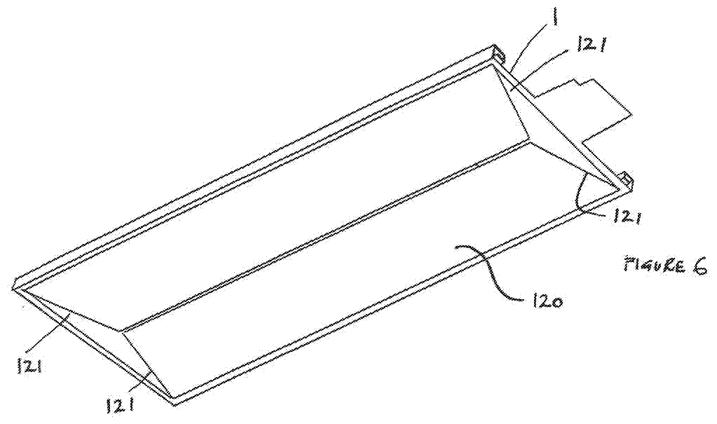

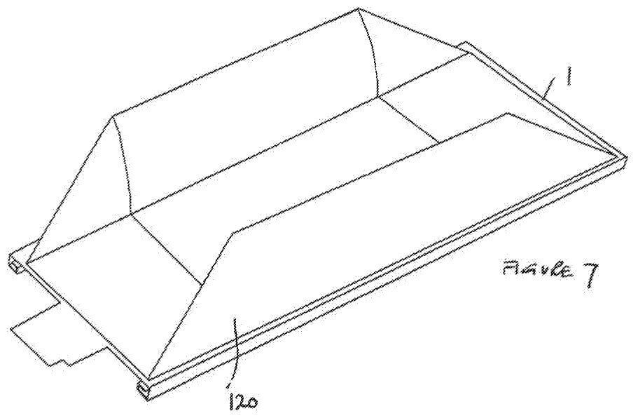

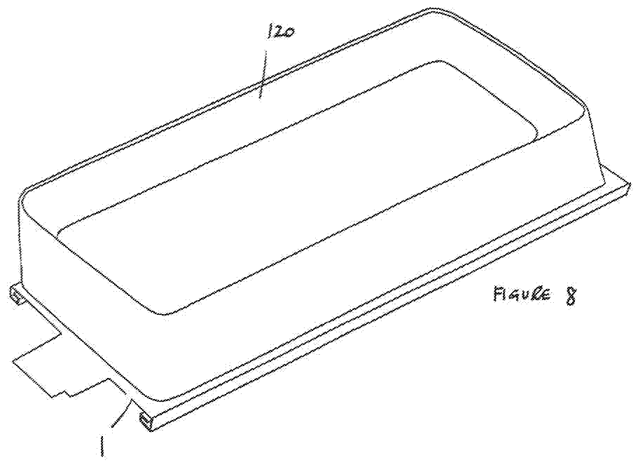

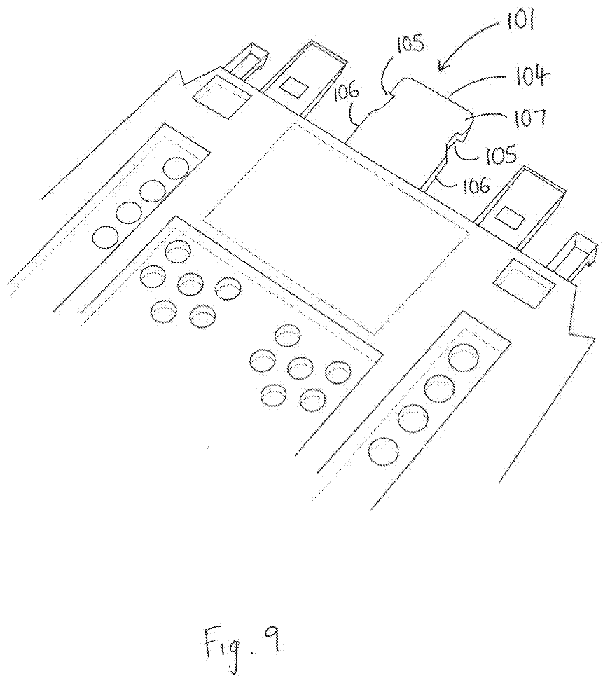

As is shown in FIG. 4, the insert 93, comprises an elongate plate 94 from which extends forwardly a tongue 95. This tongue is adapted to fit within the central box section 79 of the carrier 1. The tongue includes serrate projections 96 which are positioned and adapted to engage the serrations 80 unidirectionally such that once engagement is achieved the respective parts must be broken to allow separation of the lid and carrier. Across the tongue and behind the serrate projections 96 is a barrier wall 97 which closes the mouth of the central box section 79 when the lid is fully inserted into the carrier.

At each side of the tongue 95 is a respective one of two projections 98, which when the lid is inserted fully into the carrier extend through the apertures 78 between the section 79 and the sections 77 of the carrier. These projections 98 may thereby allow release of the carrier form the mechanism previously described. At each end of the insert 93 is another one of two projections 99 each of which is received by a respective side box section 77 of the lid 1.

Each of the inserts 75 and 93 may be secured within the carrier and lid respectively by adhesive or heat treatment. Of course, in alternative arrangements, it is possible that they may be integrally formed with the carrier and lid, respectively.

FIG. 5 shows the carrier 1 and the lid 5 in section. Each channel 74 comprises (as shown only for the right-hand channel in FIG. 5) an outer side wall 1101, a top wall parallel to the base 71, an inner side wall 1102 and a lateral flange 1104 which extends from the bottom of the inner side wall back into the channel, leaving a gap between itself and the base 71. Except for this gap the channel 74 is a closed section. The plate 91 of the lid 5 has an outer side wall 1105 at its lateral extremity. This side wall has an inwardly extending flange 1106. The wall 1105 and the flange 1106 match and interlock with the inner space defined by the walls 1101 to 1105 and the flange 1104 of the channel 74, the flange 1106 engaging the flange 1104 in the vertical direction to resist separation of the lid and carrier at their side margins. The base 91 also has an inner upstanding wall 1106 which extends upward to engage the inner side of the inner wall 1103 of the channel 74. It will be seen that the base of the lid fits into the gap to close the channel 74.

FIGS. 6 to 8 illustrate the carrier 1 and an attached bag 120 which is intended for use with a mechanism that includes a spring loaded platform below the bag. The bag 120 has a rectangular mouth secured to the margins of and below the carrier 1 and four corner pleats 121 which allow the bag to fold flat as shown in FIG. 6. FIG. 7 shows the bag partially expanded and FIG. 8 shows the bag fully expanded, at which time the enclosed bank notes will fill the bag and be held under the flaps in the carrier 1. The use of such a bag in conjunction with a sprung supporting platform renders the use of an elasticated bag unnecessary.

Other formations of the bag 120 may be adopted, such that the bag can expand from a folded, flat configuration to a full state below the carrier.

FIGS. 9 to 13 show a lock 100 according to a first embodiment of the present invention. The lock 100 comprises a first member 101 shaped to form an irreversible lock with a correspondingly shaped second member 102. The first member 101 comprises a male member and the second member 102 comprises a female member. In alternative arrangements these may be swapped. An apparatus comprising a carrier and a lid in accordance with that described by reference to FIGS. 1 to 8 may be provided in which the insert 93 is modified/replaced by the first member 101 and the insert 75 is modified/replaced by the second members 102 or vice versa, to provide an apparatus comprising a carrier and a lid in accordance with the present invention. Such an apparatus will comprise a carrier 1 being adapted to receive bank notes and having side portions 74 into which the lid 5 can be slid to prevent access to the bank notes in the carrier, the side portions of the carrier having means (as seen in FIG. 5) for engaging with side portions of the lid, the lid having a leading edge comprising the first member 101 shaped to form an irreversible lock with the correspondingly shaped second member 102 on the carrier.

The lock will now be described in greater detail with reference to the apparatus. It is to be noted, however, that the lock may be taken independently of such apparatus for application in various alternative fields. All of the features discussed herein may be applied to such a lock in such other fields. It is further to be noted that for provision of a tamper proof lock/apparatus, as is an aim of the present invention, it will be sufficient that the lock may not be opened without the same being evident.

Moreover, in accordance with the aspects discussed in the introductory portion of the specification above, various elements may be taken in isolation or in combination with one another.

FIGS. 9 and 10 illustrate a lid for use with the carrier 1 shown in FIG. 1. It comprises a generally flat plate 91 and two longitudinal side portions which fit slidingly into the channels 74 of the carrier 1. At its front end the lid comprises an insert 93. The insert 93 may be separately formed to the lid or may be integrally formed. The lid may comprise a single piece moulding, as shown, which is preferred.

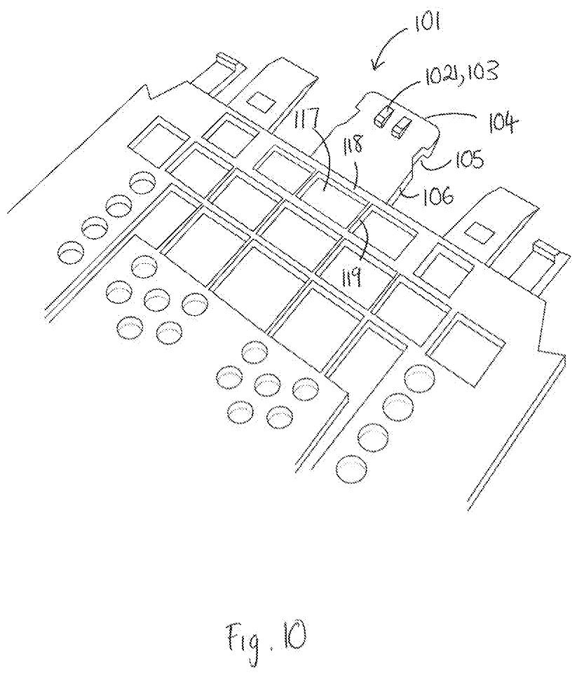

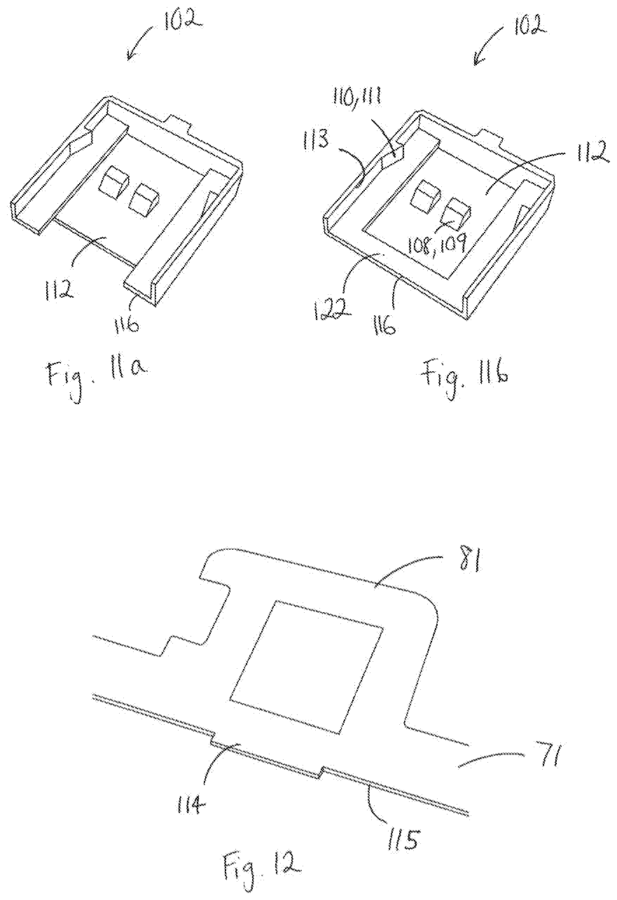

The male member 101 comprises a serrate part 102, which projects in a direction normal to the plane of the lid. The female member 102, alternative arrangements of which are shown in FIGS. 11a and 11b, comprises a serrate part 108, which projects in a direction normal to the plane of the female member (and normal to the plane of the lid, when the lid and the carrier are engaged). The male member further comprises an interlocking part 105, which lies in the plane of the lid. The female member 102 further comprises an interlocking part 110, which projects in the plane of the female member (and in the plane of the lid, when the lid and carrier are engaged). The serrate parts 102, 108 of the male and female members and the interlocking parts 105, 110 of the male and female members are respectively positioned to engage one another to prevent withdrawal of the lid from the carrier.

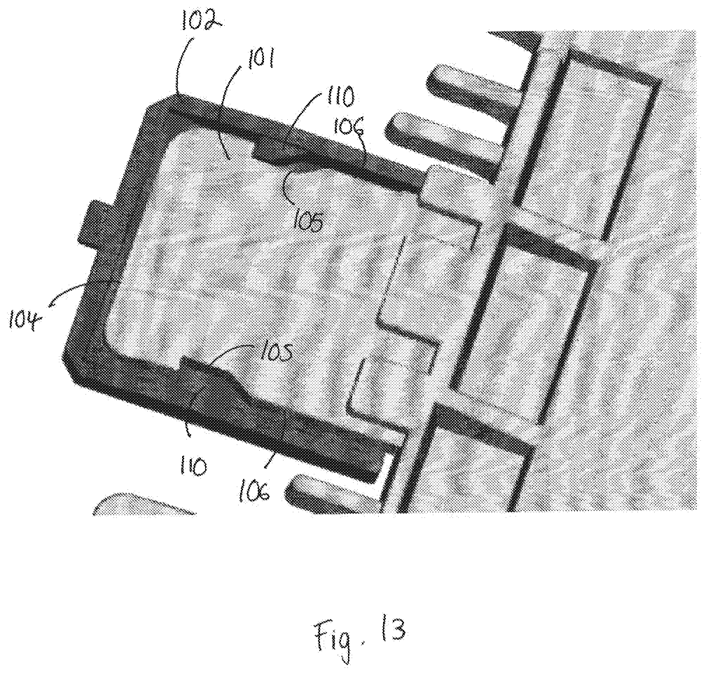

The serrate part 108 of the female member comprises a ramp 109, which is arranged such that engagement of the ramp 109 by the serrate part 103 of the male member (in particular by a ramp 103 of the serrate part 102 of the male member) during insertion of the male member 101 into the female member 102, causes the male member to be spaced from a surface 112 of the female member from which the serrate part 108 of the female member 102 projects, the spacing permitting a portion of the male member 101 to pass over the interlocking part 110 of the female member, thereby permitting an interlocking engagement of the interlocking parts 105, 110, as shown in FIG. 12.

As clearly shown in the present arrangement, there are multiple serrate parts and multiple interlocking parts on each of the male and female members. The male member 101 comprises a pair of spaced serrate parts 1021 that are aligned with one another in the sliding direction. The female member 102 comprises a corresponding pair of serrate parts 108. The female member comprises a pair of interlocking parts 110, in the form of projections, which are provided on opposed sidewalls 113 and project toward one another. The male member comprises a pair of corresponding notches 105 formed in side edges of the male member. The notches are arranged to least partially receive the interlocking parts of the male member.

The male member comprises a front edge 104, which is the forward most point of the male member in an insertion/sliding direction of the male and female members. The front edge enters the female member first during engagement of the male and female members. The serrate parts 1021 are provided adjacent the front edge. They are both spaced from the front edge by the same distance. The ramps 103 of the serrate parts of the male member are forwards of the interlocking parts 105 of the male member 101 in the sliding direction, i.e. they are spaced further from the front edge than the ramps.

It is to be understood that there could be more or less of either or both the serrate parts and the interlocking parts. They may further be formed differently, i.e. larger or smaller, or otherwise arranged. The invention is not to be limited in this regard.

The male member 101 is preferably substantially planar, as clearly seen in the figures. As discussed above in respect of the arrangement of FIGS. 1 to 8, the male member preferably comprises a tongue.

The portion of the male member that passes over the interlocking part of the female member is spaced from/free from the serrate part 1021. It is substantially planar. It is preferably the thinnest part of the male member. In the present arrangement it comprises the side edge portions of the male member, spaced transversely outside the portion of the male member that comprises the serrate parts.

The surface 112 from which the serrate parts 108 project forms a base of the female part 102. A top (omitted from FIGS. 11a, 11b and 13 for clarity) is provided which is spaced from the base in the direction normal to the plane of the lid. The top is substantially planar. The top is substantially closed, such that access to the serrate parts/interlocking parts is prevented. For this purpose it may be entirely closed or could have one or more small openings. The top and base are joined by the side walls 113, which extend between the base and top substantially normal to the lid and base.

The top of the female member may have a sloped front portion that receives a correspondingly shaped sloped front portion of a top face 107 of the male member 101, as seen in FIG. 9.

A spacing between the top and the interlocking parts on the female member is preferably less than a spacing between lid and the serrate part of female member.

As is apparent from the figures and description, noting that the top of the female member is omitted for clarity, the female member comprises a hollow formation that is substantially closed except for an open mouth. The arrangement is preferably such that the male member substantially closes off the mouth of the female member when the male and female members have formed an irreversible lock.

The arrangement as described herein is such that when the male member is inserted into the female member, the ramps 103, 109 of the serrate parts will engage one another, the ramps of the serrate parts of the male member will ride up the ramps of the serrate parts of the female member. This will cause the planar body of the male member (from which the serrate parts 102 project) to be increasingly spaced from the base 112 of the female part. Portions of the male member, which are planar and spaced from/free from the serrate parts and located forward of the interlocking parts/notches 105, will pass through the space between the interlocking members 110 of the female member and the top of the female member. As the serrate parts 102, 108 clear one another, and the interlocking parts 110 are aligned with the notches that form the interlocking parts 105, the male member will resile (since it is no longer forcibly spaced from the base 112), and the interlocking parts will engage. An irreversible lock in two planes is formed.

Whilst the use of male and female members 101, 102 as described above (comprising serrate parts, which project in a direction normal to the plane of the lid, and interlocking parts) is preferred, there may be arrangements where the male and female members are otherwise formed.

Further aspects, which may be taken in isolation from one another or in any combination with one another, and which may be combined with the above described male and female members 101, 102 or taken independently thereof, will now be described. Whilst these additional aspects will be described in the context of an embodiment comprising the above described male and female members 101, 102 this is not to be limiting. For example, the arrangement of FIGS. 1 to 8 could be amended to form an embodiment of the present invention by the introduction of one or more or all of the following aspects (whilst omitting the use of the above described male and female members 101, 102).

In one aspect, a shield 114 is provided which projects from, or from adjacent to, the mouth of the female member. The shield 114 is shown in FIG. 12, which represents a partial perspective view of a leading portion of the base 71 of the carrier with the insert that defines the female member 102 (as seen in FIGS. 11a and 11b) removed. As above, the female member 102 is preferably defined by a central box section that fits over the front tab 81 extending forwardly from the base 71 of the carrier 1. In the present arrangement, the shield is integrally formed with the base 71. However, various alternative arrangements will be readily conceived by those skilled in the art. Its projection from the mouth of the female member 102 in the present arrangement is as a result of the mouth of the female member 102 being substantially aligned with an edge 112 of the base 71 from which the shield 111 projects. In the present arrangement, the edge 116 of the insert defining the female member 102, which edge 116 defines the mouth of the female member 102, is preferably aligned with the edge 115 of the base of the carrier.

The shield 114 is preferably provided on (or at least adjacent to) an edge of the mouth of the female member 102 that lies adjacent to the bag 120/adjacent to the surface 112 of the female member from which the serrate part 108 of the female member 102 projects.

By the provision of the shield, access to the mouth of the female member 102 and/or access to the serrate parts 1021, 108 is significantly hindered, which further adds to the security of the apparatus. In this regard, it is important to note that the specific form of the shield and its means of formation/attachment are not critical as long it projects from/adjacent from the mouth to shield access to the mouth.

The shield 114 preferably has a width substantially equal to the width of the male member 101, however, it is not particularly limited in this regard. It could be narrower or wider than the male member 101. It could be narrower, wider or substantially equal in width to the mouth of the female member 102.

The shield may be substantially planar, as shown in FIG. 12 or could have some alternative three-dimensional form. The projection from the mouth need not be significant for the shield to be effective. In the present embodiment it projects from the mouth by a distance of 5 mm or less, although this need not be the case.

In another aspect, a surface of the lid that faces the carrier comprises a recess 117 immediately adjacent to the first member (male member 101 in the present embodiment), as shown in FIG. 10. The recess is separated from the first member 101 by a rib 118, which is preferred but need not be the case. In the present embodiment there are three recesses provided immediately adjacent the first member 101, which are arranged in a row. The first member at least partially spans all three of the recesses in the width direction as shown. The recesses are separated from one another by ribs 119. It should be appreciated that there could be more or less recesses provided. A single recess only could be provided. Moreover, as shown, there may be multiple rows of recesses to form a grid like pattern of separating ribs. Whilst the recesses are rectangular in form in the present embodiment and are arranged in rows this need not be the case.

By the provision of the recess, access to the mouth of the female member 102 and/or access to the serrate parts 1021, 108 is yet further hindered, which further adds to the security of the apparatus. A tool is likely to enter the recess (or one of the recesses where multiple recesses are provided) rather than the mouth. In this regard, it is important to note that the specific form/arrangement of the recess (or recesses) is not critical as long it hinders access to the mouth.

In yet further aspects, a barrier 122 is provided inside the female member 102 immediately adjacent the mouth as shown in FIG. 11b and/or a barrier is provided inside the female member 102 so that it is spaced between the mouth and the serrate part(s) 108 of the female member 102 as also shown in FIG. 11b.

FIG. 11a shows an alternative female member 102 in which the barrier 122 is omitted.

The barrier may substantially span the width of the mouth. It may span the width of the male member 101. It may span the width of the portion of the male or female member that is provided with the serrate parts 1021, 108.

The barrier most preferably projects from the surface 112 of the female member from which the serrate part 108 of the female member 102 projects. The barrier may have a flat surface that lies spaced from and parallel to the surface 112 of the female member, as shown. The barrier may comprise a rib.

It is to be noted, however, that the form of the barrier is not particularly limited. The purpose of the barrier is to provide a further obstruction to any tool that a would be thief may seek to insert through the mouth of the female part 102 for disengaging the lock. The barrier has the further benefit that it will obstruct the passage of serrate parts 1021 of the male member 101 during any attempted release of the male part 101 from the female part 102. In this regard, the barrier could be formed as a further serrate part.

In a final aspect a trailing edge of the carrier (not shown) comprises a third member (not shown) shaped to form an irreversible lock with a correspondingly shaped fourth member (not shown) on the carrier, one of the third and fourth members comprising a male member and the other of the third and fourth members comprising a female member, and a cover fixed to the lid for covering the third member to prevent access thereto.

The cover is preferably fixed to a face of the lid that faces away from the carrier when the lid and carrier are engaged. The cover is fixed such that its removal will be evident. It may be welded or adhered to the lid.

The third member is preferably unitarily formed with the lid. It may be integrally moulded with the lid.

The third member preferably comprises a serrate part, which unidirectionally engages with a corresponding feature on the carrier.

The form of the cover is not particularly limited as long as access to the third member is blocked. The cover will completely cover the third member.

It is to be noted that as with the first and second members, there may be multiple third and fourth members provided or only a single third member and single fourth member.

Additional, preferred, features of the apparatus, which may be incorporated into any of the above described embodiments/combined with any of the above described aspects include:

The provision of a plurality of holes in the lid, which are formed to allow some or all of the contents of the bag 120 of the carrier to be marked in the event of tampering and to prevent withdrawal of the contents therethrough and/or such holes within the bag 120 itself.

The provision of covering tabs for covering some or all of the openings to the channels 74 of the side portions of the carrier. Such covering tabs may be formed by the second member.

1. An apparatus comprising:
a carrier; and
a lid, the carrier having side portions into which the lid can be slid to prevent access, the side portions of the carrier having means for engaging with side portions of the lid, the lid having a leading edge comprising a first member shaped to form an irreversible lock with a correspondingly shaped second member on the carrier, one of the first and second members comprising a male member and the other of the first and second members comprising a female member,
wherein the male and female members each comprise a serrate part, which projects in a direction normal to the plane of the lid, when the lid and the carrier are engaged,
wherein the male and female members further each comprise an interlocking part,
wherein the serrate parts of the male and female members and the interlocking parts of the male and female members are respectively positioned to engage one another to prevent withdrawal of the lid from the carrier, and
wherein the serrate part of the female member comprises a ramp, which is arranged such that engagement of the ramp by the serrate part of the male member, during insertion of the male member into the female member, causes the male member to be spaced from a surface of the female member from which the serrate part of the female member projects, the spacing permitting a portion of the male member to pass over the interlocking part of the female member, thereby permitting an interlocking engagement of the interlocking parts.

2. The apparatus as claimed in claim 1, wherein the male member is substantially planar.

3. The apparatus as claimed in claim 1, wherein the male member comprises a tongue.

4. The apparatus as claimed in claim 1, wherein the portion of the male member that passes over the interlocking part of the female member is substantially planar.

5. The apparatus as claimed in claim 1, wherein the portion of the male member that passes over the interlocking part is spaced from/free from the serrate part.

6. The apparatus as claimed in claim 1, wherein the surface from which the serrate part projects forms a base of the female part and a top is provided which is spaced from the base in the direction normal to the plane of the lid, when the lid and carrier are engaged.

7. The apparatus as claimed in claim 6, wherein a spacing between the top and the interlocking part on the female member is less than a spacing between lid and the serrate part of female member.

8. The apparatus as claimed in claim 6, wherein the top is substantially closed.

9. The apparatus as claimed in claim 6, wherein the top and base are joined by one or more side walls that extend between the base and top substantially normal to the lid and base, and the interlocking part of the female member projects from the side wall in the plane of the lid, when the lid and carrier are engaged.

10. The apparatus as claimed in claim 1, wherein the interlocking part of the female member comprises a notch and the interlocking part of the female member comprises a projection, which is arranged to be at least partially received by the notch.

11. The apparatus as claimed in claim 6, wherein the female member comprises a hollow formation that is substantially closed except for an open mouth.

12. The apparatus as claimed in claim 11, wherein the male member is formed such that it substantially closes off the mouth of the female member when the male and female members have formed an irreversible lock.

13. The apparatus as claimed in claim 1, wherein the male member comprises a front edge, which is the forward most point of the male member in an insertion direction extending along an insertion axis of the male and female members, and the serrate part is adjacent the front edge.

14. The apparatus as claimed in claim 13, wherein the ramp of the serrate part of the male member is forwards of the interlocking part of the male member in the insertion direction.

15. The apparatus as claimed in claim 1, wherein there are multiple serrate parts and/or multiple interlocking parts on each of the male and female members.

16. The apparatus as claimed in claim 14, wherein the top and base are joined by one or more side walls that extend between the base and top substantially normal to the lid and base, and the interlocking part of the female member projects from the side wall in the plane of the lid, when the lid and carrier are engaged, and wherein the female member comprises a pair of the interlocking parts, which are provided on opposed sidewalls and project toward one another.

17. A lock comprising:
a first member shaped to form an irreversible lock with a correspondingly shaped second member, by relative sliding movement of the two members, one of the first and second members comprising a male member and the other of the first and second members comprising a female member,
wherein the male and female members each comprise a serrate part, which projects in a direction normal to a plane of the female member,
wherein the male and female members further each comprise an interlocking part,
wherein the serrate parts of the male and female members and the interlocking parts of the male and female members are respectively positioned to engage one another to prevent withdrawal of the female member from the male member, and
wherein the serrate part of the female member comprises a ramp, which is arranged such that engagement of the ramp by the serrate part of the male member, during insertion of the male member into the female member, causes the male member to be spaced from a surface of the female member from which the serrate part of the female member projects, the spacing permitting a portion of the male member to pass over the interlocking part of the female member, thereby permitting an interlocking engagement of the interlocking parts.

18. An apparatus comprising:
a carrier; and
lid, the carrier being adapted to receive bank notes, or other items, and having side portions into which the lid can be slid to prevent access to the bank notes, or other items, in the carrier, the side portions of the carrier having means for engaging with side portions of the lid, the lid having a leading edge comprising a first member shaped to form an irreversible lock with a correspondingly shaped second member on the carrier, one of the first and second members comprising a male member and the other of the first and second members comprising a female member,
wherein the female member comprises a mouth for receiving the male member and a shield, which projects from or from adjacent to the mouth.

19. The apparatus as claimed in claim 18, wherein the shield has a width substantially equal to the width of the male member.

20. The apparatus as claimed in claim 18, wherein the shield is provided on an edge of the mouth that lies adjacent to a base of the carrier and/or adjacent to a bag or pouch affixed to the carrier for receiving the bank notes or other items.

21-41. (canceled)
